(19) United States
(12) Patent Application Publication
(10) Pub. No.: US 2018/0370401 A1
(43) Pub. Date: Dec. 27, 2018

(54) HEATING AND COOLING SYSTEM FOR VEHICLES

(71) Applicant: Glenn Francis Miller, Melbourne, FL (US)

(72) Inventor: Glenn Francis Miller, Melbourne, FL (US)

(21) Appl. No.: 15/633,025

(22) Filed: Jun. 26, 2017

(51) Int. Cl. B60N 2/56; A47C 7/74

(52) U.S. Cl. CPC B60N 2/5657; A47C 7/744; B60N 2/5692

(57) ABSTRACT

A seat cooling system for vehicles. The seat cooling system includes a housing formed of an insulating material. The housing includes a vent and an outlet. A nozzle extends from the outlet of the housing. A fan is positioned to move air through the nozzle. The present invention may further include a seat having an outer casing and a padding disposed within the outer casing. The nozzle is connected to an inlet of the outer casing. Air is drawn into the housing through the vent, through the nozzle and into the seat.

### BACKGROUND OF THE INVENTION

The present invention relates to a cooling system for vehicles and more particularly, a seat cooling system for vehicles with exposed cabins.

Temperature control systems for vehicles are desirable. Current outdoor vehicles with exposed cabins, such as golf carts, all-terrain vehicles, utility vehicles, fishing boats, lawn mowers, delivery trucks and the like, do not have effective and efficient temperature control systems. For example, some outdoor vehicles have a fan that blows existing outside air onto a user. The fans are ineffective in cooling the user, as the air blown onto the user is not cooled.

As can be seen, there is a need for an improved cooling system for vehicles with exposed cabins.

### SUMMARY OF THE INVENTION

In one aspect of the present invention, a seat cooling system for a vehicle comprises: a housing formed of an insulating material, wherein the housing comprises a vent and an outlet formed therethrough; a nozzle extending from the outlet of the housing; a fan positioned to move air through the nozzle; and a seat comprising an outer casing comprising an inlet and a padding disposed within the outer casing, wherein the nozzle is connected to the inlet of the seat so that the fan draws air into the housing through the vent and blows air from the housing into the seat.

In another aspect of the present invention, a cooling device comprises: a housing formed of an insulating material, wherein the housing comprises a vent and an outlet formed therethrough; a nozzle extending from the outlet of the housing; a radiator disposed at an entrance of the nozzle and comprising coils and a tube running through the coils, wherein the tube comprises a first end and a second end; a pump; a tubing running from a bottom of the housing to the first end of the tube; and a coolant, wherein the pump pumps the coolant through the tubing and into the tube of the radiator, and the fan draws air through the vents, through the radiator and out of the nozzle.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a perspective view of an embodiment of the present invention with a cutaway portion illustrating internal vertical tubes;

FIG. 3 is a perspective view of an embodiment of the present invention;

FIG. 4 is a cutaway view of an embodiment of the present invention illustrating internal components of the present invention;

FIG. 5 is a section cutaway view of an embodiment of the present invention illustrating internal components of the present invention; and

FIG. 6 is a section detail view of the present invention taken along line 6-6 in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

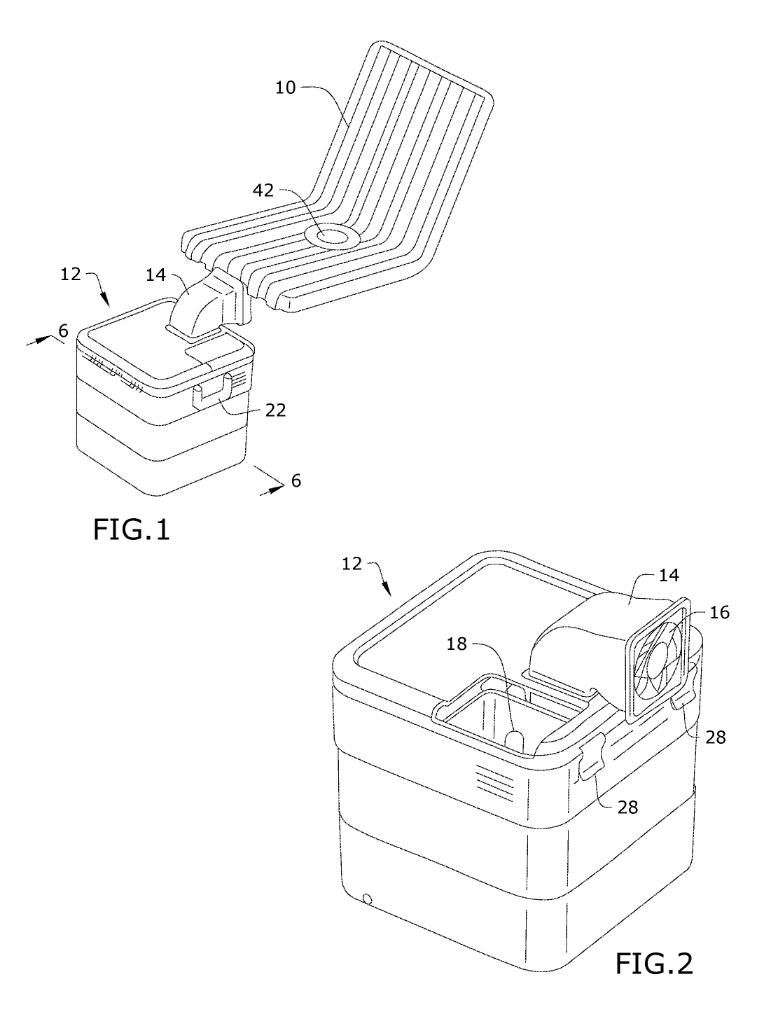

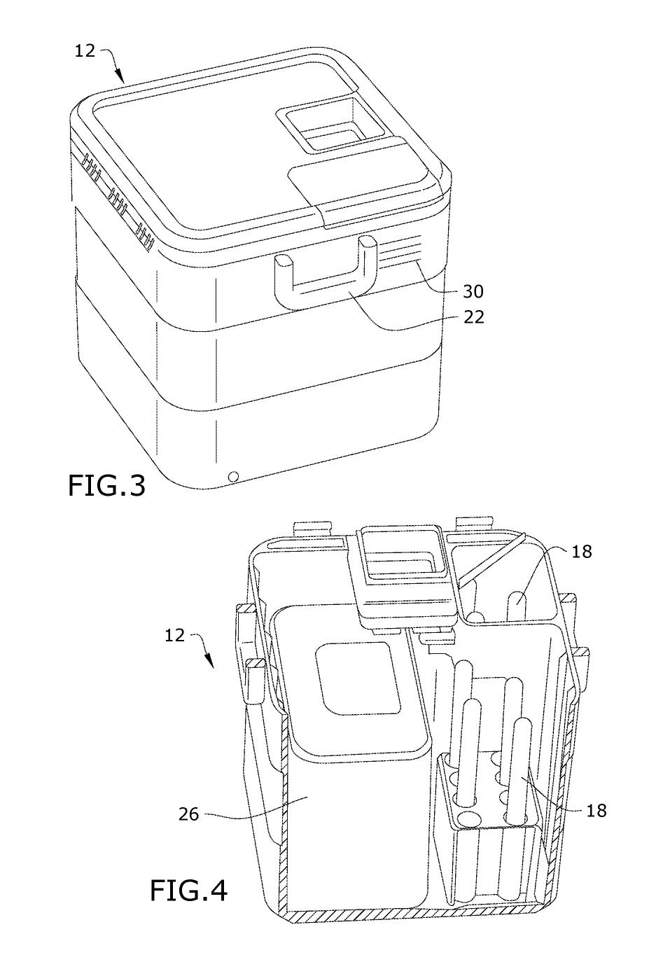

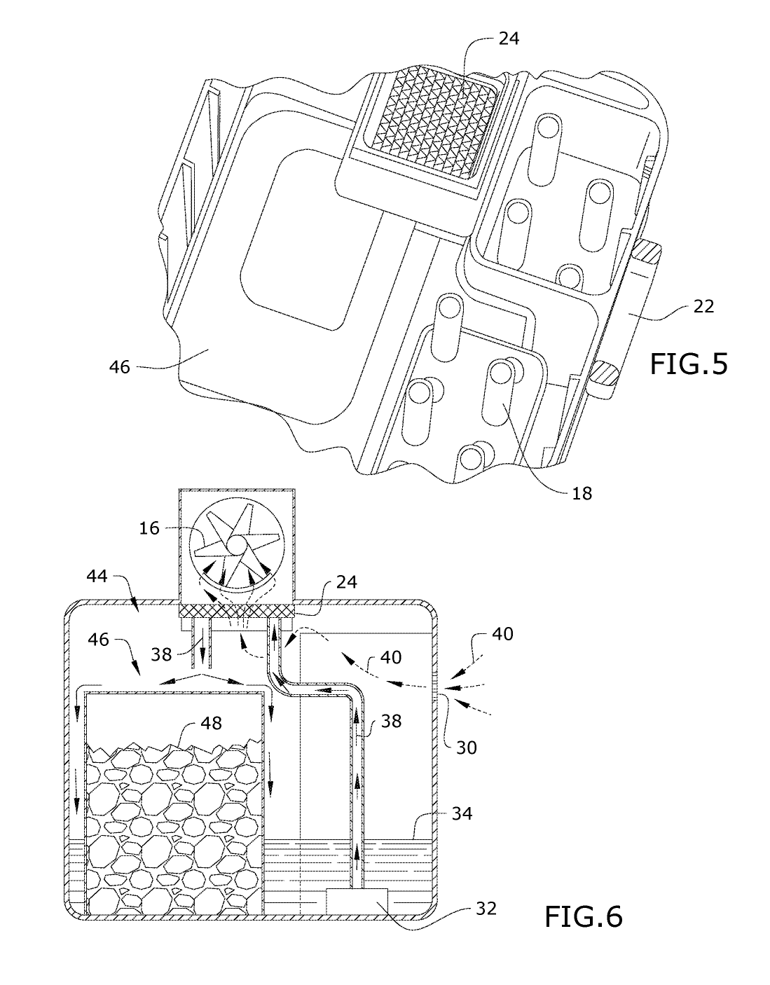

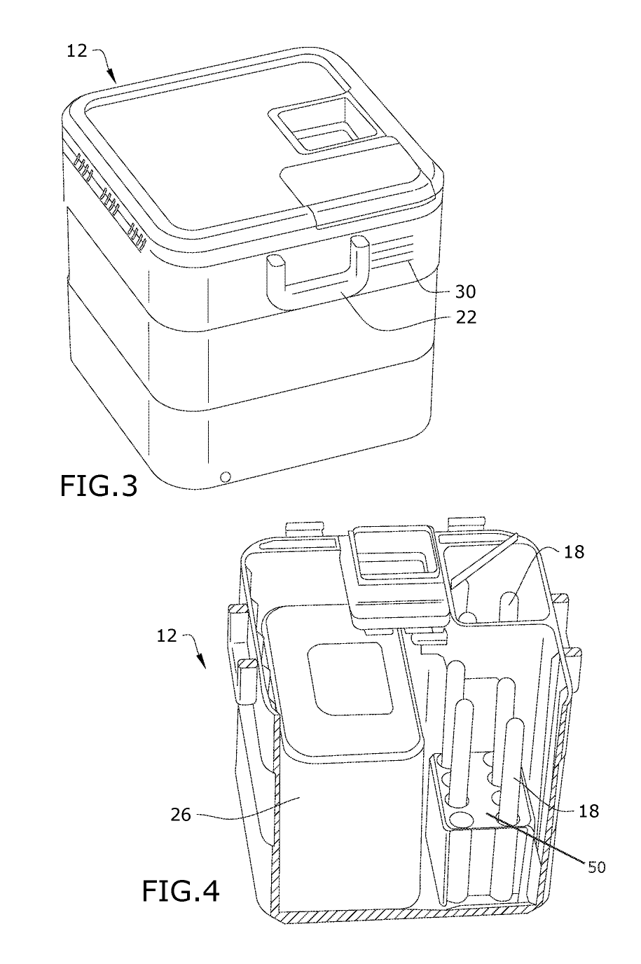

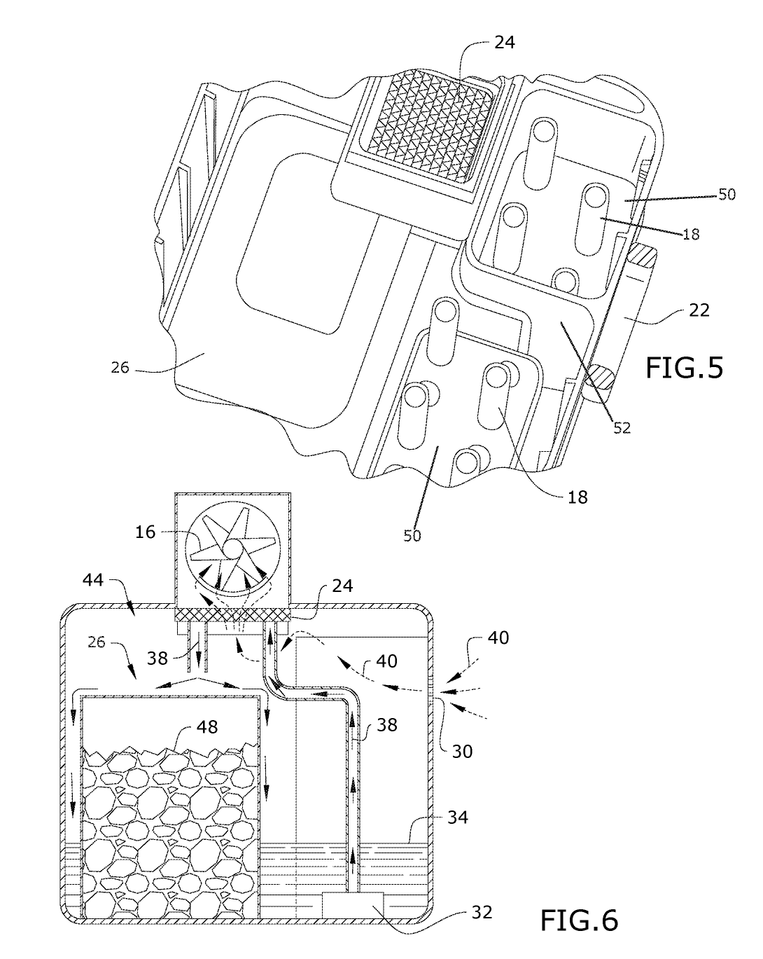

Referring to FIG. 1 through 6, the present invention includes a seat cooling system for vehicles. The seat cooling system includes a housing 12 formed of an insulating material. The housing 12 includes a vent 30 and an outlet. A nozzle 14 extends from the outlet of the housing 12. A fan 16 is positioned to move air through the nozzle 14. The present invention may further include a seat 10 having an outer casing and a padding disposed within the outer casing. The nozzle 14 is connected to an inlet of the outer casing. Air 40 is drawn into the housing 12 through the vent 30, through the nozzle 14 and into the seat 10.

The housing 12 of the present invention may be in the shape of a box, with a base, a vertically extending sidewall, and a top wall. A pair of handles 22 may be secured to the sidewall. In certain embodiments, the top wall is a lid attached to a top rim of the sidewall by hinges. Latches 28 may lock the lid in a closed position. The lid allows users to open and close the housing 12 to access internal components. As mentioned above, the housing 12 is made of an insulating material. Therefore, ice and cold water placed within the housing may remain cold for an extended period of time. The housing 12 may be made of materials similar to a cooler, such as plastics, hard foams and the like.

The present invention may include a plurality of ice and cold water containers within the housing 12 to cool the air. For example, the present invention may include an ice box 26 that stores ice 48 within. The present invention may further include tube racks 50 having apertures that support metal tubes 18 within. The metal tubes 18 may have cold water and ice disposed within.

In certain embodiments, the housing 12 may be partitioned by an internal sidewall 52. The internal sidewall 52 forms a small compartment and a large compartment. A first tube rack 50 and a first set of metal tubes 18 may be disposed within the small compartment. The vent 30 may lead into the small compartment and the fan 16 may draw air through the metal tubes 18, over the top of the internal sidewall 52 and out through the nozzle 14. The metal tubes 18 may remove moisture and cool down the air. A second rack 50 and a second set of metal tubes 18 may be disposed in the large compartment. The second set of metal tubes 18 may replace the first set of metal tubes 18 when the ice within the first set of metal tubes 18 has melted.

The present invention further includes a coolant system disposed within the housing 12. The coolant system includes a radiator 24 disposed at an entrance of the nozzle 14. The radiator 24 includes a tube running through metal coils. The coolant system further includes a pump 32 and a tubing 36 running from a bottom of the housing 12 to a first end of the tube of the radiator 24. A coolant 34, such as water, is contained at the bottom of the housing 12. The ice 48 and ice box 26 keep the coolant 34 cold. The pump 32 pumps the coolant 34 through the tubing 36 and into the tube of the radiator 24. The coolant 34 may exit a second end of the radiator 24 and enter a discharge tubing that spills the coolant 34 onto the ice box 46. The coolant 34 drips down the bottom of the housing 12 to be pumped again. The fan 16 draws air through the radiator and out of the nozzle 14, further cooling the air.

The seat 10 of the present invention may be a fixed seat of the vehicle or a seat cover. As mentioned above, the seat 10 includes an outer casing and a padding disposed within the outer casing. The padding may include tubbing or an open cell foam. The cold air may travel through the tubing or open cells of the foam and cool the seat 10.

The fan 16 may be powered by a separate battery or a battery of the vehicle. The present invention may include a switch which turns the fan 16 off and on. Alternatively, the fan 16 may be turned on and off based on a pressure reading of a pressure sensor 42. In such embodiments, the seat 10 may include a sensor 42. The sensor 42 may include a pressure sensor. The sensor 42 detects a threshold pressure applied to the seat 10 and sends a signal to power the fan 16. The fan 16 thereby turns on and begins blowing cold air into the seat 10. When the sensor 42 no long detects pressure or detects a pressure lower than the threshold pressure, the fan 16 may automatically turn off.

It should be understood, of course, that the foregoing relates to exemplary embodiments of the invention and that modifications may be made without departing from the spirit and scope of the invention as set forth in the following claims.

1.-6. (canceled)

7. A cooling device comprising:
a housing formed of an insulating material, wherein the housing comprises a vent and an outlet formed therethrough;
a nozzle extending from the outlet of the housing;
a radiator disposed at an entrance of the nozzle and comprising coils having a first end and a second end;
a pump;
a fan;
an ice box disposed within the housing below the radiator;
a tubing running from a bottom of the housing to the first end of the coils; and
a coolant, wherein
the pump pumps the coolant through the tubing and into the coils of the radiator,
the coolant runs through the coils and spills out of the second end of the coils onto the ice box, and
the fan draws air through the vents, through the radiator and out of the nozzle.

8. The cooling device of claim 7, further comprising a tube rack disposed within the housing adjacent to the vent and comprising a plurality of openings, and a plurality of tubes comprising ice within, wherein the plurality of tubes are supported by the tube rack.

9. (canceled)

10. The seat cooling system of claim 7, wherein the housing comprises a lid attached to a sidewall by a hinge, and a latch operable to lock the lid in a closed position.
